(19) United States
(12) Patent Application Publication
(10) Pub. No.: US 2007/0256097 A1
(43) Pub. Date: Nov. 1, 2007

(54) Apparatus and Method for Executing Broadcast Application

(76) Inventor: Gyung-pyo Hong, Gyeonggi-do (KR)

Correspondence Address: SUGHRUE MION, PLLC, 2100 PENNSYLVANIA AVENUE, N.W., SUITE 800, WASHINGTON, DC, 20037, US

(21) Appl. No.: 10/584,217

(22) PCT Filed: May 1, 2004
(86) PCT No.: PCT/KR04/01018

§ 371 Date: May 22, 2007

(30) Foreign Application Priority Data
Dec. 23, 2003 (KR) 10-2003-0095630

(51) Int. Cl. G06F 3/00

(52) U.S. Cl. 725/38

(57) ABSTRACT

An apparatus and method for executing a broadcast application are provided. The apparatus includes a data filter which extracts broadcast application data for executing a broadcast application provided by a predetermined broadcast channel among broadcast channels that are not currently watched by a user from a broadcast stream of the predetermined broadcast channel, data storage unit which stores the extracted broadcast application data, and an application execution unit which fetches the broadcast application data from the data storage unit in response to an application execution command input by the user after the user's selection of the predetermined broadcast channel and executes the broadcast application using the fetched broadcast application data.

### TECHNICAL FIELD

The present invention relates to an apparatus and method for executing a broadcast application, and more particularly, to an apparatus and method for quickly executing a broadcast application, in response to channel change by a user, by previously acquiring application data for executing an application provided through a channel that is not currently tuned by the user.

### BACKGROUND ART

Recently, due to the wide spread of digital broadcasts, demands on broadcast applications (hereinafter, referred to as applications) have increased. Accordingly, there is a growing trend to include various contents in applications that previously included only a simple menu form. In addition, broadcast receivers that provide contents to users more rapidly have been increasingly researched and developed. At present, JAVA applications that are highly compatible with different types of machines are prevalent.

FIG. 1 illustrates a conventional method of executing an application in response to channel change. When a user tunes in to digital broadcast channel 1 and an application for a current program exists, an application driving software module in a broadcast receiver recognizes application data in abroadcast stream and then starts to receive the application data. After receiving either a part of or the entire amount of the application data, the application driving software module displays information indicating that the application is executable on a screen. Then, the user issues a command using either the function buttons on a digital television remote control or the function buttons on a panel of a digital television. In response to the command, the application driving software module executes the application data that was received in advance. The application driving software module does not execute the application upon recognition of the existence of the application data in the broadcast stream; rather, an acquisition delay occurs, which is defined as the time it takes for the application driving software module to collect the application data. The acquisition delay occurs because a waiting time is required from when the application data in the broadcast stream is requested at which time the application data does not exist, to when all of the necessary data from the requested application has been extracted.

However, it takes a long time to load an application carried in a broadcast stream due to the complexity of the application and the large amount of application data. Hereinafter, time taken to load an application is referred to as ‘acquisition time’. In other words, an application carried in a broadcast stream is executed far more slowly than an application that has been previously stored in a personal computer or a hard disc. Accordingly, it is desirable to provide a method that allows a user who is viewing a digital broadcast to use an application sooner after the application is executed.

### DISCLOSURE OF INVENTION

The present invention provides a method of quickly and efficiently providing a broadcast application to a user.

According to an aspect of the present invention, an apparatus for executing a broadcast application is provided. The apparatus comprises a data filter which extracts broadcast application data for executing a broadcast application that is provided by a broadcast stream of a predetermined broadcast channel among broadcast channels that are not being watched by a user, a data storage unit which stores the extracted broadcast application data, and an application execution unit which fetches the broadcast application data from the data storage unit in response to an application execution command input by the user after the user's selection of the predetermined broadcast channel and which also executes the broadcast application using the fetched broadcast application data. Preferably, the user directly selects the broadcast application; otherwise, it is selected based on user information indicating how much the user favors each broadcast application. The broadcast application is preferably comprised in the broadcast stream of the predetermined broadcast channel that can be provided to the user by at least one tuner that is not being used. Preferably, the broadcast application is selected based on user information indicating how much the user favors each broadcast application. The user information may comprise the number of times the broadcast application has been executed, or the length of time the user executed the broadcast application.

According to another aspect of the present invention, a method of executing a broadcast application is provided. The method includes extracting broadcast application data for executing a broadcast application that is provided by a broadcast stream of a predetermined broadcast channel among channels that are not being watched by a user, storing the extracted broadcast application data, and fetching the stored broadcast application data in response to a command to execute the broadcast application and executing the broadcast application using the fetched broadcast application data.

Preferably, the user directly selects the broadcast application; otherwise it is selected based on user information indicating how much the user favors each broadcast application. The broadcast application is preferably comprised in the broadcast stream of the predetermined broadcast channel that can be provided to the user by at least one tuner that is not being used. Preferably, the broadcast application is selected based on user information indicating how much the user favors each broadcast application. The user information may comprise the number of times the broadcast application has been executed, or the length of time the user executed the broadcast application.

### BRIEF DESCRIPTION OF DRAWINGS

The above and other features and advantages of the present invention will become more apparent by describing in detail preferred embodiments thereof with reference to the attached drawings in which:

FIG. 1 illustrates a conventional method of executing an application in response to channel change;

FIG. 2 is a diagram of a structure of a usual broadcast channel;

FIG. 3 illustrates an execution of an application according to an embodiment of the present invention;

FIG. 4 illustrates a block structure for executing an application according to an embodiment of the present invention;

FIG. 5 is a flowchart of a method of executing an application according to an embodiment of the present invention; and

FIG. 6 is a flowchart of a method of executing an application according to another embodiment of the present invention.

### BEST MODE FOR CARRYING OUT THE INVENTION

Hereinafter, an apparatus and method for executing a broadcast application according to preferred embodiments of the present invention will be described in detail with reference to the attached drawings.

FIG. 2 is a diagram of a structure of a standard broadcast channel. As shown in FIG. 2, a single physical channel includes N virtual channels. A physical channel is an actual frequency range through which a broadcast stream is transmitted. A virtual channel is a unit channel through which a single broadcast program is transmitted. A single physical channel may include two or more virtual channels or may include a single virtual channel for high-resolution broadcast.

Embodiments of the present invention will be briefly described in connection with the structure of a broadcast channel shown in FIG. 2. For example, let's assume that a single physical channel includes a plurality of virtual channels. In this case, while a user is watching virtual channel 1, application data transmitted through other virtual channels included in the physical channel is stored in a separate memory area based on specific user information. Thereafter, when the user changes virtual channels and executes an application for a newly tuned virtual channel, the application is immediately executed without a delay due to the acquisition of application data. In other words, application data provided by virtual channels that the user is not watching is stored in advance so that the stored application data is available to the user immediately after the user changes virtual channels and executes an application for a newly tuned virtual channel. Here, it is necessary to select the virtual channels for which application data is to be stored in advance, because system resources are limited. In embodiments of the present invention, user information is used to select the virtual channels for which application data is to be stored in advance.

The user information may include, for example, channel selection information about what channels a user frequently selects, view time information about the length of time the user watched a particular channel, information about the number of application executions provided by a particular channel, and information about the length of time the user executed and used an application. Priorities among the information may be determined, or the information may be synthetically analyzed using mathematical and statistical methods. Application data for particular channels is stored based on the priority or on an analysis result.

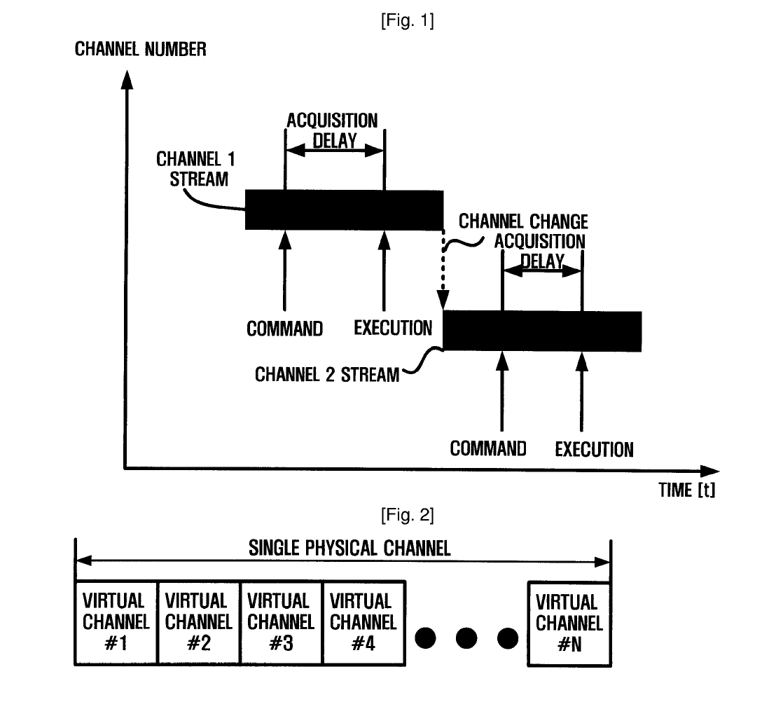

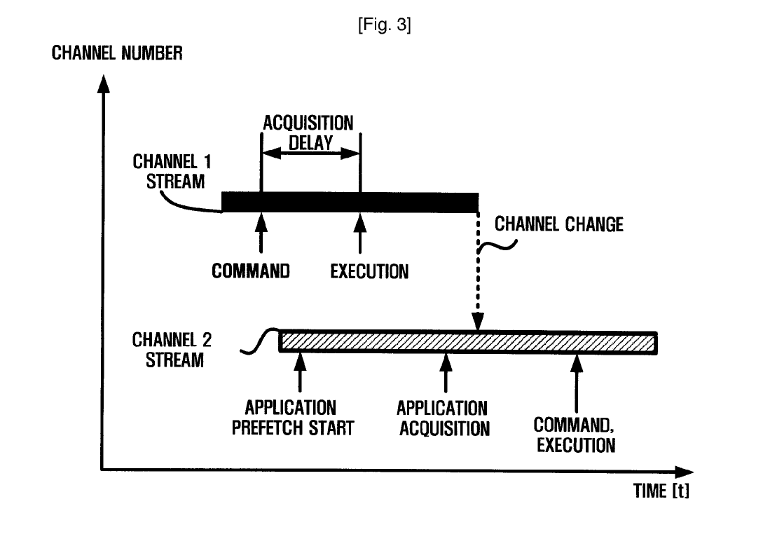

FIG. 3 illustrates an execution of an application according to an embodiment of the present invention. When a user is watching a digital broadcast provided by channel 1, and if an application for a current program exists, an application driving software module included in a broadcast receiver acquires either a part of or the entire amount of the application data from a broadcast stream. After acquiring the application data, the application driving software module informs the user of the existence of the application in a current channel, i.e., channel 1 through on a screen. Then, the user may execute the application using the function buttons on a remote control or on the broadcast receiver. Here, as described above with reference to the FIG. 1, an acquisition delay occurs. Meanwhile, let's assume that channel 2 is selected based on the user information. In this case, while the user is watching channel 1, a broadcast stream of channel 2 is received using software designed for receiving a digital broadcast or using an available tuner. Then, prefetching of application data included in the broadcast stream begins, and the application data is acquired in a predetermined acquisition time. Accordingly, the application data provided by channel 2 is stored in a physical memory area within a system. Thereafter, when the user changes channel from channel 1 to channel 2 and executes the application for channel 2, the application for channel 2 can be executed immediately in response to an application execution command without an acquisition delay, since the application data for channel 2 has been stored in the memory area.

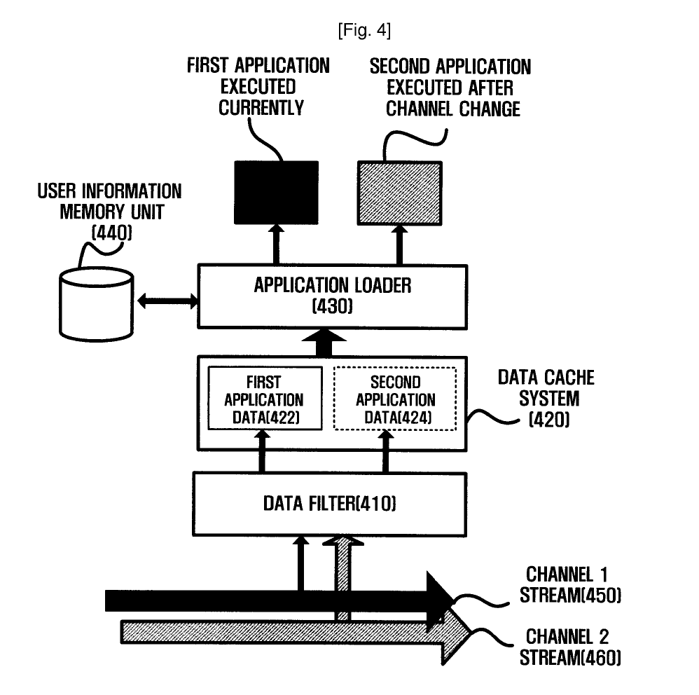

FIG. 4 illustrates a block structure for executing an application according to an embodiment of the present invention. The block structure according to the embodiment of the present invention includes a data filter 410, a data cache system 420, an application loader 430, and a user information memory unit 440. The data filter 410 extracts basic section data constituting application data from a broadcast stream of a channel selected by a user and processes the section data. The data cache system 420 receives the section data, constructs application data using the section data, and stores the constructed application data. The application loader 430 controls the data filter 410 and the data cache system 420 and manage application data stored in the data cache system 420. The user information memory unit 440 stores information about the user's favorite channels or applications. The block structure may be implemented by either hardware or software.

For example, when a user selects channel 1, the data filter 410 extracts basic section data constituting application data from the channel 1 broadcast stream 450 and transmits the section data to the data cache system 420. The data cache system 420 constructs application data for channel 1, i.e., first application data 422, using the section data received from the data filter 410 and stores the first application data 422. If the user executes an application for channel 1 that the user is watching currently, i.e., a first application, then the application loader 430 fetches the first application data 422 from the data cache system 420 and executes the first application using the first application data 422.

During the above-described operation, application data for channels that the user favors (hereinafter, referred to as favorite channels) other than a channel that the user is watching currently is stored in the data cache system 420. In other words, the application loader 430 selects favorite channels using information stored in the user information memory unit 440. The user information may include information about channels that the user frequently selects, information about the length of time each channel was executed for when an application for each channel is executed, and information about a number of executions of each application. The information may be stored in various data formats already known. The number of favorite channels selected by the application loader 430 may change according to system resources. Favorite channels may be directly selected by a user via function buttons on a remote control or on a digital television. Favorite channels directly selected by the user have priority over favorite channels selected by the application loader 430 based on the information stored in the user information memory unit 440.

If favorite channels are determined by the user's operation or the application loader 430, the data filter 410 extracts basic section data constituting application data from a broadcast stream of each favorite channel and transmits the section data to the data cache system 420. In this embodiment, let's assume that channel 2 is a favorite channel.

The data cache system 420 constructs application data for channel 2, i.e., second application data 424, using the section data received from the data filter 410 and stores the second application data 424.

Thereafter, if the user changes channel from channel 1 to channel 2 and executes an application for a program provided by channel 2, i.e., a second application, the application loader 430 fetches the second application data 424 from the data cache system 420 and executes the second application using the second application data 424. Accordingly, the second application can be immediately executed in response to an application execution command without an acquisition delay.

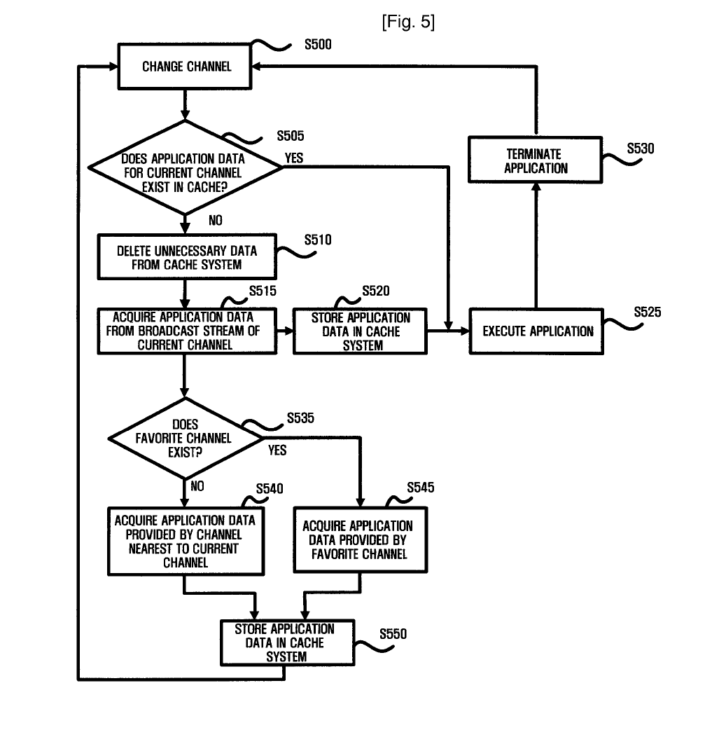

FIG. 5 is a flowchart of a method of executing an application according to an embodiment of the present invention. When a user turns on a digital television and selects a particular channel or changes channels, a program provided by a current channel is displayed on a screen of the digital television in step S500.

If the user executes an application for the current program while watching the current program, a software module ported to a broadcast receiver within the digital television or separate hardware to manage applications determines whether application data for executing the application selected by the user exists in a cache in step S505. If it is determined that the application data exists in the cache, the application data is fetched from the cache and the application is immediately executed using the fetched application data without acquiring the application data from a broadcast stream of the current program in step S525. If a user generates a channel change command by pressing function buttons on a remote control or on the digital television during the execution of the application, the application is terminated in step S530, and then channel change is performed in step S500.

If it is determined that the application data for executing the application selected by the user does not exist in the cache, unnecessary data is deleted from a cache system in step S510. Next, the application data is acquired from the broadcast stream of the current program in step S515. The application data is acquired using conventional methods. Here, the cache system includes a plurality of caches.

The application data acquired in step S515 is stored in the cache system in step S520. Next, the software module executes the application selected by the user using the stored application data in step S525.

While steps S515 through S525 are performed, the software module determines whether a favorite channel exists in step S535. The favorite channel has been described above.

If it is determined that a favorite channel exists, the software module acquires application data provided by the favorite channel in step S545 and stores the application data in the cache system in step S550. If it is determined that a favorite channel does not exist in step S535, the software module acquires application data provided by a channel nearest to the current channel that the user is watching in step S540 and then stores the application data in the cache system in step S550.

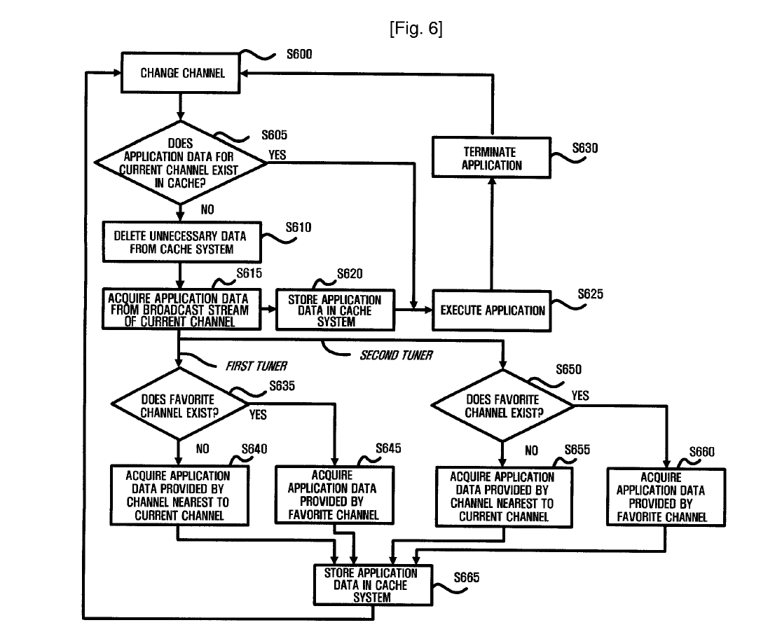

FIG. 6 is a flowchart of a method of executing an application according to another embodiment of the present invention. While the method shown in FIG. 5 is used to execute an application when the digital television includes a broadcast receiver having a single tuner, the method shown in FIG. 6 is used to execute an application when the digital television includes a broadcast receiver having at least two tuners.

Steps S600 through S630 shown in FIG. 6 are the same as steps S500 through S530 shown in FIG. 5.

While steps S615 through 625 are performed, the software module described in the method shown in FIG. 5 determines whether a favorite channel exists among channels tuned by first and second tuners. Methods of determining the existence or non-existence of a favorite channel (steps S635 and 650) and the processes that follow (S640, S645, S655, and S660) are the same as steps S535 through S550 shown in FIG. 5.

In other words, as shown in FIG. 5 or 6, application data can be previously extracted from a broadcast stream provided by a favorite channel and stored in a cache using either a hardware resource within a system or a software module that is equivalent to the hardware resource.

### INDUSTRIAL APPLICABILITY

According to the present invention, application data for a user's favorite channel is previously acquired and stored so that an application for a channel can be quickly provided at the user's request. In addition, the present invention allows broadcasting companies to obtain information about the applications favored by viewers via user information feedback in two-way digital television services.

Although a few embodiments of the present invention have been shown and described, it will be appreciated by those skilled in the art that changes or modifications may be made in these elements without departing from the spirit and scope of the invention, the scope of which is defined in the appended claims and their equivalents.

1. An apparatus for executing a broadcast application, comprising:
a data filter which extracts broadcast application data for executing a broadcast application that is provided by a broadcast stream of a predetermined broadcast channel among broadcast channels that are not being watched by a user;
a data storage unit which stores the extracted broadcast application data; and
an application execution unit which fetches the broadcast application data from the data storage unit in response to an application execution command input by the user after the user's selection of the predetermined broadcast channel and which executes the broadcast application using the fetched broadcast application data.

2. The apparatus as claimed in claim 1, wherein the broadcast application is directly selected by the user.

3. The apparatus as claimed in claim 1, wherein the broadcast application is comprised in the broadcast stream of the predetermined broadcast channel that can be provided to the user by at least one tuner that is not being used.

4. The apparatus as claimed in claim 1, wherein the broadcast application is selected based on user information indicating how much the user favors each broadcast application.

5. The apparatus as claimed in claim 4, wherein the user information comprises the number of times the broadcast application has been executed.

6. The apparatus as claimed in claim 4, wherein the user information comprises the length of time the user executed the broadcast application.

7. A method of executing a broadcast application, comprising:
extracting broadcast application data for executing a broadcast application that is provided by a broadcast stream of a predetermined broadcast channel among channels that are not being watched by a user;
storing the extracted broadcast application data; and
fetching the stored broadcast application data in response to a command to execute the broadcast application and executing the broadcast application using the fetched broadcast application data.

8. The method as claimed in claim 7, wherein the broadcast application is directly selected by the user.

9. The method as claimed in claim 7, wherein the broadcast application is comprised in the broadcast stream of the predetermined broadcast channel that can be provided to the user by at least one tuner that is not being used.

10. The method as claimed in claim 7, wherein the broadcast application is selected based on user information indicating how much the user favors each broadcast application.

11. The method as claimed in claim 10, wherein the user information comprises the number of times the broadcast application has been executed.

12. The method as claimed in claim 10, wherein the user information comprises the length of time the user executed the broadcast application.
